(19) United States
(12) Patent Application Publication
(10) Pub. No.: US 2014/0060705 A1
(43) Pub. Date: Mar. 6, 2014

(54) Method for gas-nitriding high-pressure components

(71) Applicant: Christian Graspeuntner, Hallein (AT)

(72) Inventor: Christian Graspeuntner, Hallein (AT)

(73) Assignee: Robert Bosch GMBH, Stutthgart-Feuerbach (DE)

(21) Appl. No.: 14/110,362

(22) PCT Filed: Apr. 5, 2012
(86) PCT No.: PCT/AT12/00095

§ 371 Date: Nov. 18, 2013

(30) Foreign Application Priority Data
Apr. 8, 2011 (AT) A 508/2011

(51) Int. Cl. F02M 61/16

(52) U.S. Cl. CPC F02M 61/168
USPC 148/238

(57) ABSTRACT

In a method for gas-nitriding high-pressure components of a high-pressure accumulator (rail) (1) for a common-rail injection system of an internal combustion engine, in which an internal thread of a feed or discharge opening (2) passing through the wall of the high-pressure accumulator (1) is covered during gassing, a cover screw (6) is screwed into the thread (5) to cover the thread (5).

The invention relates to a method for gas-nitriding high-pressure components, in particular a high-pressure accumulator (rail) for a common-rail injection system of an internal combustion engine, in which an internal thread of a feed or discharge opening passing through the wall of the high-pressure component is covered during gassing.

High-pressure components such as high-pressure accumulators are used in common-rail injection systems for internal combustion engines. In such injection systems, fuel is fed by a prefeed pump, optionally via a fuel filter, and via fuel lines to at least one high-pressure pump, where the fuel is compressed to system pressures of above 1400 bar, in particular up to 2200 bar. The compressed fuel reaches at least one high-pressure accumulator (rail) via high-pressure lines. Departing from the high-pressure accumulator, the fuel passed into the individual injection injectors via a flow restrictor and via further high-pressure lines.

Bearing in mind the high system pressures of up to 2200 bar, high-pressure components and, in particular, high-pressure accumulators are exposed to extremely high mechanical loads. It is, therefore, required to subject specific high-pressure components to a hardening treatment, wherein gas-nitriding is usually applied. Gas-nitriding comprises a thermochemical treatment by which the workpiece to be treated is heated and exposed to a nitrogen-containing gas such as ammonia both during the heating period and during the treatment period. The diffusing nitrogen causes the formation of nitrides in the surface layer of the workpiece. The nitrogen enrichment in the surface layer enhances the performance characteristics, in particular the strength behaviour under static and dynamic loads, the wear behaviour and the corrosion behaviour. In doing so, it is advantageous that the treatment will be effected at temperatures below 600° C. in order to avoid a structural transformation of the workpiece.

Nitriding, however, also leads to an increase in the brittleness of the treated high-pressure component. In particular in the region of threads, this will result in a reduction of the fatigue limit of the threads, and hence in a deterioration of the strength of the respective threaded connection and in the leakiness of the respective high-pressure connection. In order to remedy this drawback, it has already become known to cover threads prior to nitriding so as to preserve the tenacity of the material at the thread. As a rule, a cover paste is used for covering. The use of a cover paste is, however, cumbersome, particularly because the cover paste has to be elaborately removed after the completion of the nitriding operation.

Methods that do without thread covering have also become known. There, the high-pressure component is nitrided before the thread is cut into the feed or discharge opening. However, this requires an additional operating step such that the previously described methods including covering of the thread prior to nitriding are basically preferable.

The present invention, therefore, aims to provide an alternative method for covering the thread, which is simple and cost-effective to perform.

To solve this object, the method of the initially defined kind according to the invention is performed in a manner that a cover screw is screwed into the thread to cover the thread. The elaborate application and removal of a cover paste are consequently omitted. The cover screw is screwed out again after nitriding and can be readily reused for nitriding further high-pressure components.

To seal the thread against the nitriding gas on its inner side, it is preferably proceeded such that the cover screw comprises a projecting sealing edge which is screwed against a stop surface disposed radially outside a sealing cone of the feed or discharge opening. By the sealing cone of the cover screw abutting on the stop surface radially outside the sealing cone, it will be ensured that the sealing cone, which is located further inwards than the stop surface, will itself not be sealed against the nitriding gas and hence subjected to the nitriding treatment.

In order to simultaneously seal the thread against the nitriding gas also externally, it is preferably provided that, after having screwed in the cover screw, a further cover screw is used, which is screwed with its projecting sealing edge against a planar surface surrounding the thread, of the high-pressure accumulator.

The use of two separate cover screws in this case serves to avoid a double fit, wherein it is, in particular, provided that the cover screw and the further cover screw comprise an axial distance from each other in the screwed-in state.

In order to enable the cover screw(s) to be used several times, the choice of a suitable material is important. A preferred embodiment in this respect provides that the cover screw and optionally the further cover screw are made of a temperature-resistant and elastic material such as, e.g., a copper-beryllium alloy.

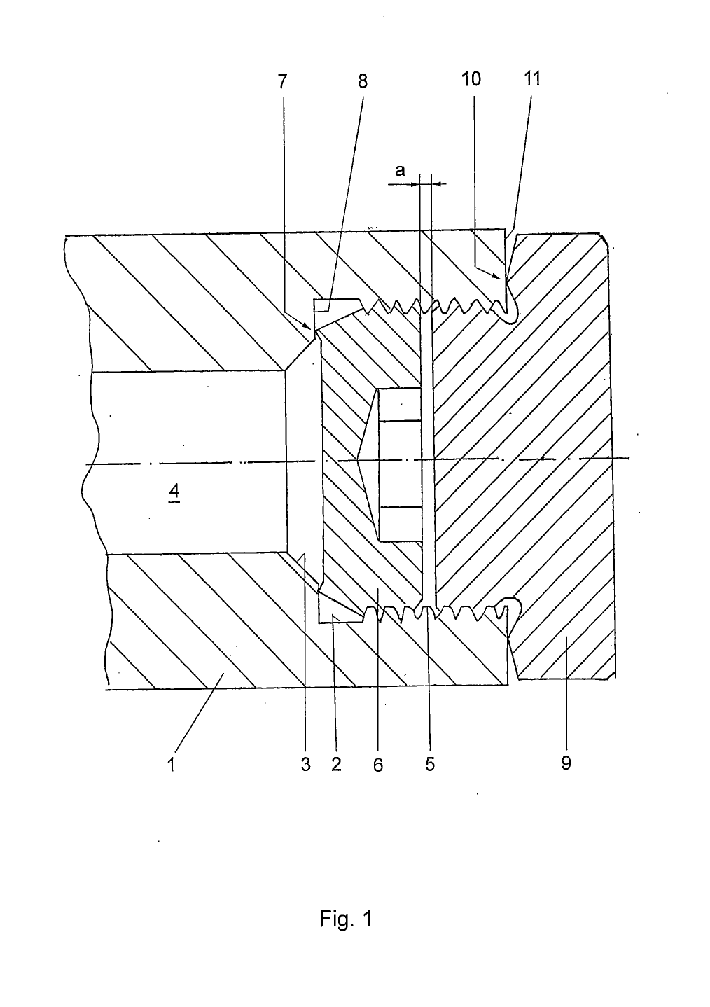

In the following, the invention will be explained in more detail by way of an exemplary embodiment schematically illustrated in the drawing. Therein, an end portion of a high-pressure accumulator 1 is schematically illustrated in FIG. 1. The high-pressure accumulator 1 comprises a feed or discharge opening 2, which opens into the interior 4 of the high-pressure accumulator 1 via a sealing cone 3. The sealing cone 3 serves to provide abutment to a conical seating of a high-pressure line screwed into the feed or discharge opening 2. The respective thread is denoted by 5. In order to prevent the thread 5 from being exposed to the nitriding gas during gas nitriding, a cover screw 6 is screwed into the thread 5 prior to the beginning of the nitriding treatment. The cover screw 6, on its end face, comprises an annular or circular sealing edge 7, which is pressed against the radial stop surface 8 as it is screwed in. In doing so, the cover screw 6 is screwed in with such a torque that an application pressure of the sealing edge 7 against the stop surface 8 results, which is sufficient to seal the thread 5. The radial stop surface 8 adjoins the sealing cone 3 towards outside such that the nitriding gas subsequently conducted into the interior 4 of the high-pressure accumulator 1 can also reach the sealing cone.

After having screwed in the cover screw 6, the further cover screw 9 is turned into the thread 5 in such a manner as to be pressed, by its sealing edge 10, which is formed on a portion overlapping the rim of the feed or discharge opening 2, against the planar surface 11 surrounding the rim of the feed or discharge opening 2. The thread 5 is thereby also externally sealed against the penetration of nitriding gas. The length of the cover screws 6 and 9 is dimensioned such that the portions provided with external threads, of the respective screws together are shorter than the length of the internal thread 5. In the screwed-in state of the cover screws 6 and 9, a distance a between the mutually facing end faces of the cover screws is thus formed.

After the nitriding treatment, the cover screws 6 and 9 can be removed.

1. A method for gas-nitriding a high-pressure accumulator (rail) (1) for a common-rail injection system of an internal combustion engine, in which an internal thread of a feed or discharge opening (2) passing through the wall of the high-pressure accumulator (1) is covered during gassing, characterized in that a cover screw (6) is screwed into the thread (5) to cover the thread (5), wherein the cover screw (6) is made of a temperature-resistant and elastic material such as e.g., a copper-beryllium alloy.

2. A method according to claim 1, wherein the cover screw (6) comprises a projecting sealing edge (7) which is screwed against a stop surface (8) disposed radially outside a sealing cone (3) of the feed or discharge opening (2).

3. A method according to claim 1, wherein after having screwed in the cover screw (6), a further cover screw (9) is used, which is screwed with its projecting sealing edge (10) against a planar surface (11) surrounding the thread, of the high-pressure accumulator (1).

4. A method according to claim 1, wherein the cover screw (6) and the further cover screw (9) comprise an axial distance (a) from each other in the screwed-in state.

5. A method according to claim 1, wherein the cover screw (6) and optionally the further cover screw (9) are made of a temperature-resistant and elastic material such as, e.g., a copper-beryllium alloy.
